(19) United States
(12) Patent Application Publication
(10) Pub. No.: US 2025/0376839 A1
(43) Pub. Date: Dec. 11, 2025

(54) SYSTEMS AND METHODS FOR MANUFACTURING CAST REGOLITH BUILDING UNITS FOR RADIATION, THERMAL AND MICROMETEOROID PROTECTION ON THE MOON

(71) Applicant: Massachusetts Institute of Technology, Cambridge, MA (US)

(72) Inventors: Nikita Klimenko, Cambridge, MA (US); Daniel Frank Massimino, Somerville, MA (US); Lanie Grace McKinney, Cambridge, MA (US); Palak Bharat Patel, Cambridge, MA (US); Juan Daniel Hurtado Salazar, Cambridge, MA (US); Annika Thomas, Cambridge, MA (US)

(21) Appl. No.: 19/230,033

(22) Filed: Jun. 5, 2025

Related U.S. Application Data
(60) Provisional application No. 63/656,221, filed on Jun. 5, 2024.

(51) Int. Cl. E04B 1/92; B28B 3/02; B28B 11/24; B64G 1/16; B64G 99/00; E04C 1/42; E04H 14/00

(52) U.S. Cl. CPC E04B 1/92; B28B 3/02; B28B 11/24; B64G 99/00; E04C 1/42; E04H 14/00; B64G 1/16; E04B 2001/925

(57) ABSTRACT

Systems and methods for manufacturing modular bricks from regolith on the surface of the moon for radiation protection and lunar habitation are provided. For example, regolith can be used to manufacture modular bricks that form maintainable and reusable structures that can provide protection from radiation on the lunar surface. In some embodiments, hollow bricks can be filled with loose regolith to leverage its radiation protection capabilities by increasing an amount of material within the structure while reducing the amount of processed material, thereby increasing the radiation protection afforded by the structure. The bricks can be shaped like hexagonal prisms to promote stacking with one another in the absence of binding materials while also allowing for tolerance during positioning. Manufacturing of the bricks can involve melting lunar regolith in a heating device, casting it into hollow hexagonal prism bricks, filling these bricks with regolith, and assembling them into structures.

### CROSS-REFERENCE TO RELATED APPLICATION

The present disclosure claims priority to and the benefit of U.S. Provisional Application No. 63/656,221, entitled “Cast Regolith Bricks for Radiation, Thermal, and Micrometeroid Protection on the Moon,” filed on Jun. 5, 2024, the content of which is incorporated by reference herein in its entirety.

### FIELD

The present disclosure relates to systems and methods for manufacturing structures for radiation protection on the lunar surfaces, and more particularly relates to systems and methods for manufacturing modular building units from regolith on the surface of the moon for radiation protection and lunar habitation.

### BACKGROUND

In recent years, space exploration has become a hot button topic for the scientific community. Whether due to explosive population growth, prolonged lifespans, or the anticipation of reduction of Earth's resources, humans ability to travel to, and eventually live on, the moon and other planets has been at the forefront of a new technological age. The U.S., along with 39 other Artemis Accords signatories, are committed to engaging in peaceful and sustainable development of human presence on the moon in the next two decades. The National Aeronautics and Space Administration (NASA) has spent billions of dollars on research and equipment in pursuit of its long-standing aim to enable sustained lunar habitation, which can support science and commercial activities as part of the Moon to Mars objectives. For long-term human habitation on the moon, a significant amount of radiation protection will be required around lunar habitats to mitigate exposure to ionizing radiation and protect astronaut's long-term health.

Despite recent technological breakthroughs, space travel and habitation faces several significant difficulties before becoming widely feasible. For example, NASA and other entities that plan to design lunar habitats need to determine how to develop robust radiation protection when in space due to the absence of the Earth's atmosphere to protect them from cosmic radiation. While these materials exist on Earth, bringing the materials to space as part of a payload is unduly expensive and can be burdensome due to weigh, space, and size limitations. Moreover, due to cosmic strikes, such as from meteoroids or other foreign debris striking and/or destroying these lunar habitats, there is an inherent risk to humans who are depending on these habitats for survival. Specifically, one such strike can damage a habitat, with the possibility of repair being infeasible due to resource shortages or exorbitant expense, putting lives at risk and terminating the use of the habitat indefinitely.

Accordingly, there is a need for systems and methods that leverage space resources to enable sustainable long-term habitation on the moon and other celestial bodies.

### SUMMARY

The present application is directed to systems and methods for manufacturing modular building units, or bricks, from regolith on the surface of the moon for radiation protection and lunar habitation. For example, regolith from the moon can be used to manufacture modular bricks that form maintainable and reusable structures that can encase habitable lunar environments. Leveraging regolith as building material allows for minimizing payload brought in from earth to build such structures, which minimizes launch costs and allows investment in advances in other manufacturing techniques. In some embodiments, hollow bricks can be filled with loose regolith to leverage its radiation protection capabilities and to weigh down the structure. Filling the bricks with loose regolith can also increase an amount of material within the structure, thereby increasing the radiation protection afforded by the structure. The bricks can be shaped like hexagonal prisms to promote stacking with one another in the absence of binding materials while also allowing for tolerance when positioning bricks relative to one another. The bricks can offer modularity in designing a radiation protection structure that can be reused and maintained to encase the habitats to enable sustainable long-term habitation on the moon.

Manufacturing and construction of the bricks can occur by melting the regolith, e.g., in a furnace, stove, oven, or another heating device designed to melt objects, without any beneficiation, and cast into a hollow brick designed specifically for fully autonomous robotic assembly. The hollow glass-casted brick can then be filled with regolith to decrease annealing time and/or reduce energy demands. The bricks can be transported to the structure, where, for example, a robotic arm attached to a rover and a vertical elevating platform can assemble the bricks into corbelled arches and domes. The back-weighting of the corbelling technique can provide a stable structure without the need for any of metal supports, mortar, and/or other binders, which means the bricks can be replaced and the structure maintained over time.

One exemplary embodiment of a method of minimizing radiation exposure includes manufacturing one or more bricks from loose regolith and assembling the one or more bricks into a structure having corbelled arches. The one or more bricks are formed by melting loose regolith to form a molten regolith and casting the molten regolith into a hollow hexagonal prism brick. The structure encases a habitation in an interior hollow portion thereof.

The one or more bricks can be fooled with loose regolith. Casting the molten regolith can include transferring a gob having a volume of the molten regolith into an opening of a mold to shape the one or more bricks, with the mold having a top portion and a bottom portion, pressing the gob with a plunger having a shape of a negative, hollow space of the opening of the mold, continuing pressing the gob until a final shape and a temperature of the molten regolith is below its softening point, removing the plunger and the top portion of the mold, removing the one or more bricks from the mold, and annealing and cooling the one or more bricks. In some embodiments, the mold can be preheated.

Assembling the one or more bricks into the structure can include grasping and placing the one or more bricks on one another using a robot assembly system. The one or more bricks can be glass-casted. Assembling the structure having corbelled arches can use about 2 MW of power. A first brick of the one or more bricks can be removed from the structure having corbelled arches to form a void and a second brick of the one or more bricks can be inserted to fill the void. No gaps can be formed between the second brick and adjacent bricks when the second brick is inserted to fill the void.

Melting the loose regolith to form one brick of the one or more brick can use about 2600 MJ of energy. In some embodiments, the loose regolith can be melted in a furnace powered by at least one of fission surface power or solar power.

One exemplary embodiment of a structure includes a sidewall composed of molten regolith that is cast into a hexagonal prism shape with one or more faces of the sidewall defining an opening having an interior lumen formed therein.

The interior lumen can include loose, unrefined regolith. A weight of the structure containing the loose, unrefined regolith can be about 7,500 kilograms. A thickness of the sidewall can be about 2.54 centimeters.

One example embodiment of a radiation shielding structure includes a plurality of bricks composed of cast molten regolith. Each brick of the plurality of bricks has a hollow interior portion filled with loose regolith. The plurality of bricks are assembled into corbelled arches having an inner volume defined therein. The brick of the plurality of bricks can have a hexagonal prism shape. The structure can be devoid of metal supports, mortar, or binders. Each brick of the plurality of bricks can have a substantially equal height, length, and width as another brick of the plurality of bricks. Each brick of the plurality of bricks can have a substantially equal weight as another brick of the plurality of bricks. The plurality of bricks having corbelled arches can be stable without external supports or centering.

The plurality of bricks can have from about 2,000 bricks to about 20,000 bricks. The inner volume can include a habitation that is configured to be inflated to fill the inner volume, with the habitation being capable of supporting human life. The habitation can include structures based on at least one of harmonic numbers or Mycenaean Tholos Tomb. The plurality of bricks may not be held together with mortar.

### BRIEF DESCRIPTION OF THE DRAWINGS

This disclosure will be more fully understood from the following detailed description taken in conjunction with the accompanying drawings, in which:

FIG. 1 is a perspective view of one example of a brick of the present embodiments;

FIG. 2A is a front view of the brick of FIG. 1 having an opening formed in a face thereof;

FIG. 2B is a perspective view of the brick of FIG. 2A;

FIG. 2C is another perspective view of the brick of FIG. 2A;

FIG. 3 is a perspective view of a plurality of bricks of FIG. 1 being stacked;

FIG. 4 is a perspective view of another embodiment of a brick having an opening formed in its front face;

FIG. 5 is a perspective view of a prior art robotic system having a robotic arm that is configured to grasp the bricks of the present embodiments;

FIG. 6A is a perspective view of one embodiment of a habitat having a plurality of capsules;

FIG. 6B is a perspective view of the bricks of FIG. 1 being stacked to construct a structure around the habitat of FIG. 6A;

FIG. 6C is a perspective view of the bricks of FIG. 1 being further stacked to construct a structure around the habitat of FIG. 6A;

FIG. 6D is a perspective view of the bricks of FIG. 1 being still further stacked to construct a structure around the habitat of FIG. 6A;

FIG. 6E is a perspective view of the bricks of FIG. 1 being yet further stacked to construct a structure around the habitat of FIG. 6A;

FIG. 6F is a perspective view of a plurality of structures constructed on a lunar surface, including the habitat of FIG. 6E;

FIG. 7A is a front view of one embodiment of a hollow portion of the capsule of FIG. 6A;

FIG. 7B is a cross-sectional view of the hollow portion of the capsule of FIG. 7A taken along line B-B in FIG. 6A; and

FIG. 8 is a schematic illustration of one embodiment of a method for casting bricks of the present embodiments.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the systems and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Terms commonly known to those skilled in the art for components and/or processes of the structure, function, manufacture, and use of the devices and methods disclosed herein and the like may be used interchangeably herein. A person skilled in the art, in view of the claims, present disclosure, and knowledge of the skilled person, will understand such terms are merely examples of such components and/or processes, and other components, designs, processes, and/or actions are possible.

The present disclosure generally relates to leveraging lunar regolith for the manufacturing and construction of a radiation protection structure that can be reused and maintained. For example, the radiation protection structure can align with NASA's long-standing aim to enable sustained lunar habitation, which can support science and commercial activities as part of the Moon to Mars objectives. In view of this aim, the present disclosure can be used to construct large habitat and lunar village configurations that produces radiation shielding that can be compatible with evolving infrastructure of different morphologies and increasing volume, compatible with autonomous assembly, and resistant to single-point failures. The present disclosure provides for novel structures and methods for developing three major systems of preparing the structures of the present embodiments: i) manufacturing; ii) transport; and iii) construction.

At least one novel feature of the present embodiments can include creating a modular construction unit that balances extending the structural capacity of lunar regolith, with simultaneously expanding its architectural utility and radiation shielding potential, and minimizing the energy used to produce the functional unit. The building units, which can be referred to as bricks in at least some instances, can be manufactured by casting and filling a hollow interior portion of the bricks with unprocessed regolith for enhanced radiation protection. For the purposes of this disclosure, the term “bricks” is not limited to conventional rectangular-shaped bricks, and can be used to refer to modular building units, blocks, or another structure understood by one skilled in the art to be able to be combined and/or stacked on one another to build a large structure.

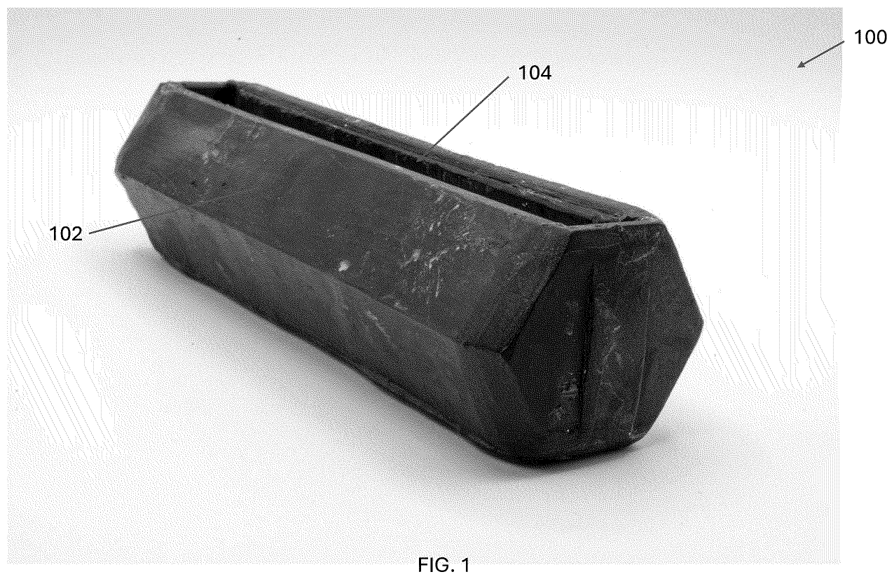

FIG. 1 illustrates an embodiment of a brick 100 that can be manufactured for the modular architectures of the present embodiments. As shown, the brick 100 can include a sidewall 102 having an opening 104 formed therein. The sidewall 102 can be shaped as a hexagonal prism, as shown, which is a shape that allows for ease of autonomous assembly. For example, when a plurality of bricks 100 are assembled with robotic assistance, a hexagonal geometry can predetermine the placement of the bricks and reduce failure modes due to robotic error when assembling modular bricks to form the architecture of the present embodiments. Use of hexagonal prisms can minimize calibration errors when placing subsequent bricks on one another, with bricks being brought in proximity to other bricks and then using gravity to slide them into place when building the structure. Bricks having these shapes can exhibit good load distributing capabilities, and can be easily calibrated to minimize and/or eliminate gaps that can cause instability and allow radiation leakage into the interior structure. Moreover, hexagonally-shaped bricks can be assembled in the absence of binding materials, e.g., mortar, which are not native to the moon and would need to be imported from Earth as part of the payload, thereby greatly increasing construction costs. It will be appreciated that in some embodiments, rectangular, square, triangular, pyramidal, rhombal, and so forth, prism shapes can be used in lieu of, and/or in addition to, the hexagonal-shaped bricks of the present embodiments.

It will be appreciated that many different brick shapes were considered to determine a shape of the bricks 100 of the present embodiments, though they can be generally categorized into four categories. For example, interlocking and non-interlocking versions of bricks with hexagonal and rectangular brick faces can be used for minimizing placement errors, as discussed below. Rectangular interlocking bricks can enable more stable structural configurations, but may pose some challenges to maintenance due to the entire structure being taken apart to replace a brick. Hexagonal interlocking bricks can prescribe the geometry of any circular structure and would need many different shape of bricks to enable simple arches, which may not be practical at scale. The rectangular prism may be simple to manufacture, but is more challenging for robotic assembly. To be maintainable, the bricks may be offset, and small errors in robotic assembly can accrue and require extra construction time to correct or affect structural integrity. While each of the above-shapes are within the scope of the present disclosure, hexagonal prisms are discussed herein with respect to the structures of the present embodiments. Hexagonal structures, which may be more difficult to manufacture, have a prescribed position within an arch structure, making it easier for robotic assembly. Therefore, if prioritization of case of robotic assembly and manufacture using casting is desired, the bricks 100 of the present embodiments can be used. The brick 100 can also be designed as hollow, as discussed below, to reduce the energy required per brick by an order of magnitude, and allow the interior to be filled with regolith to maintain the appropriate thickness for radiation shielding.

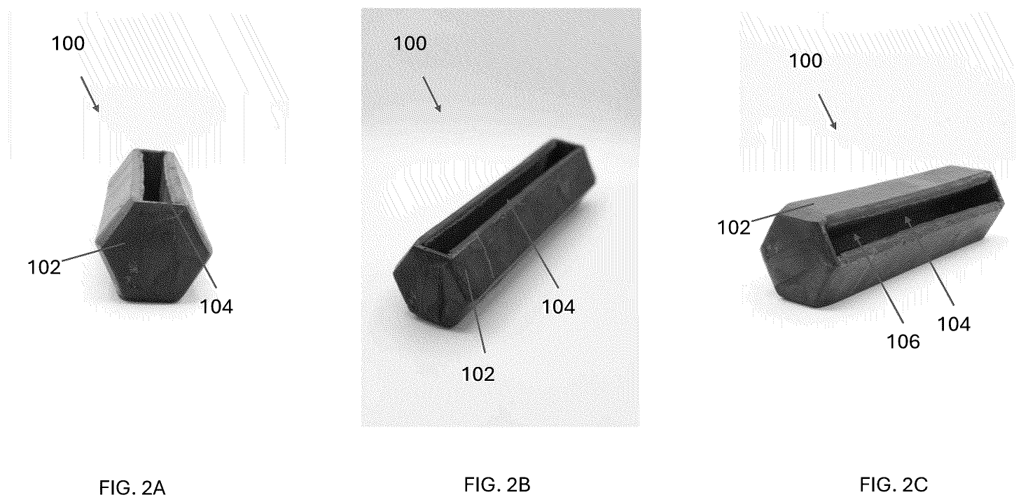

The opening 104 in the sidewall 102 can extend through a portion of one or more sides of the hexagonal-shaped sidewall 102 into an interior lumen 106, as shown in FIGS. 2A-2C. The interior lumen 106 can be configured to receive regolith therein. For example, in some embodiments, each of the bricks 100 can be filled with loose, unprocessed regolith. The addition of the loose regolith into the interior lumen 106 can enhance protection by increasing an amount of the regolith material to shield from radiation.

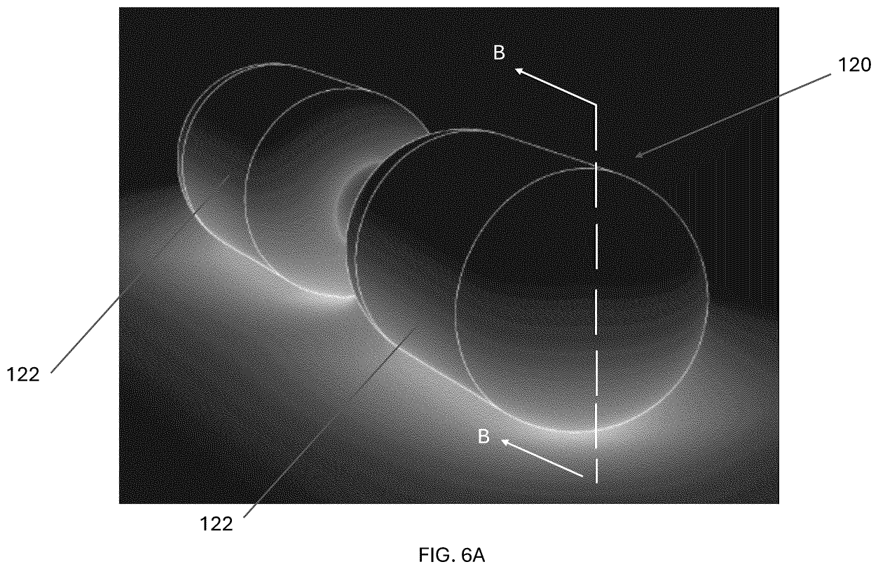

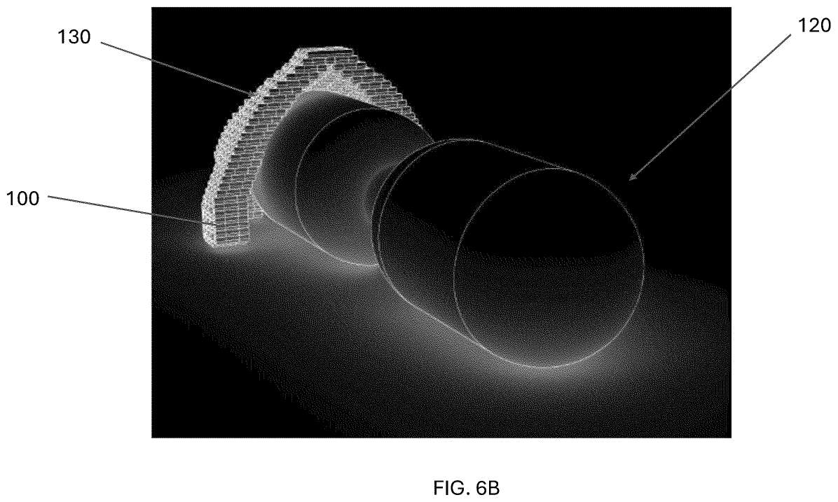

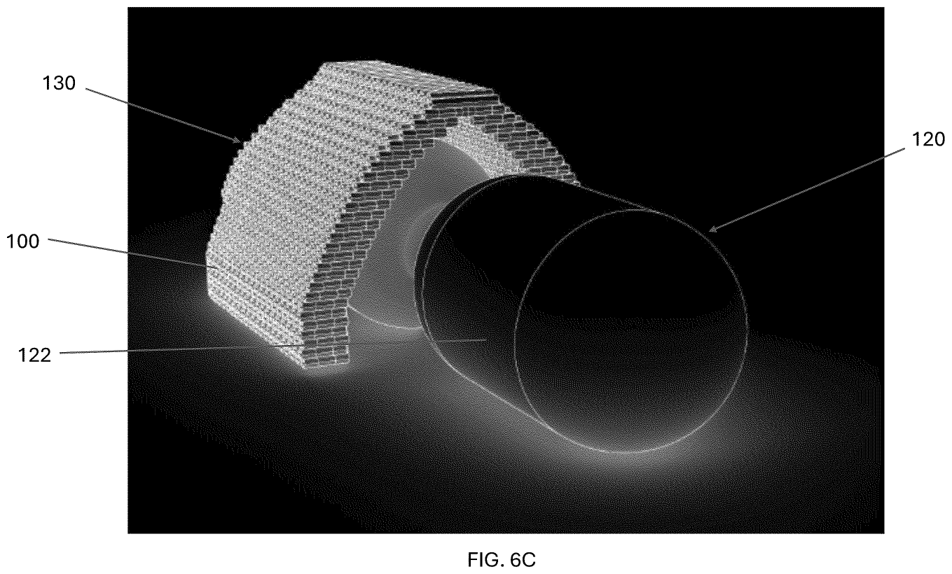

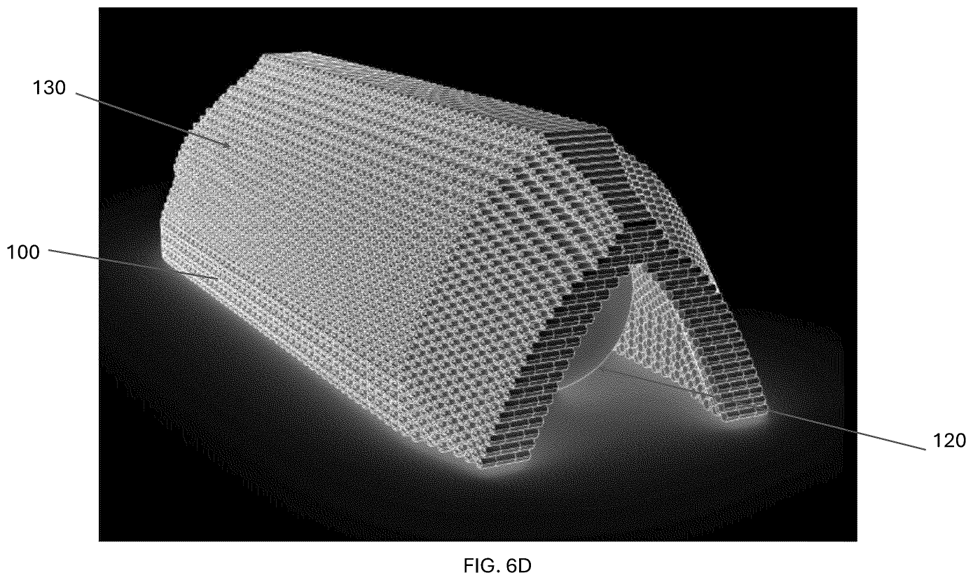

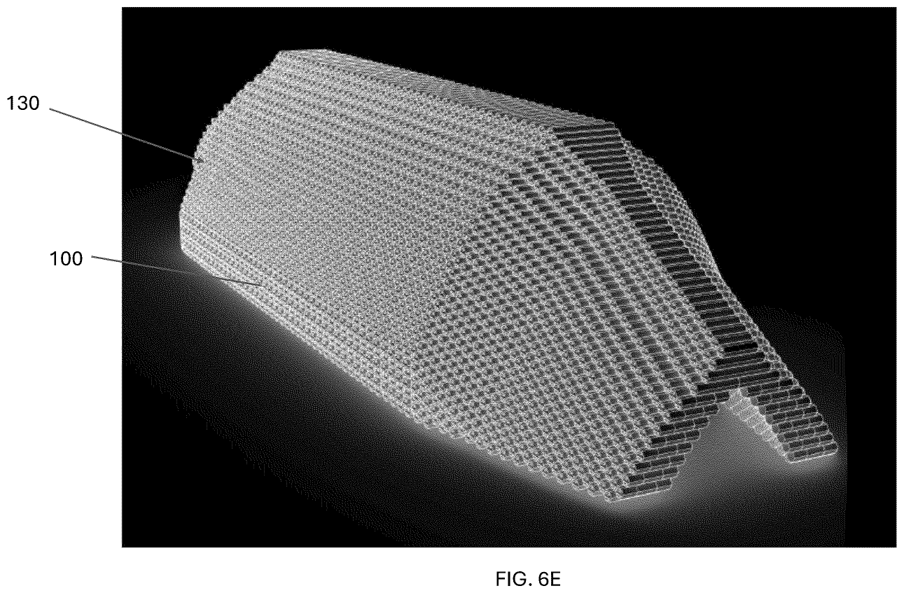

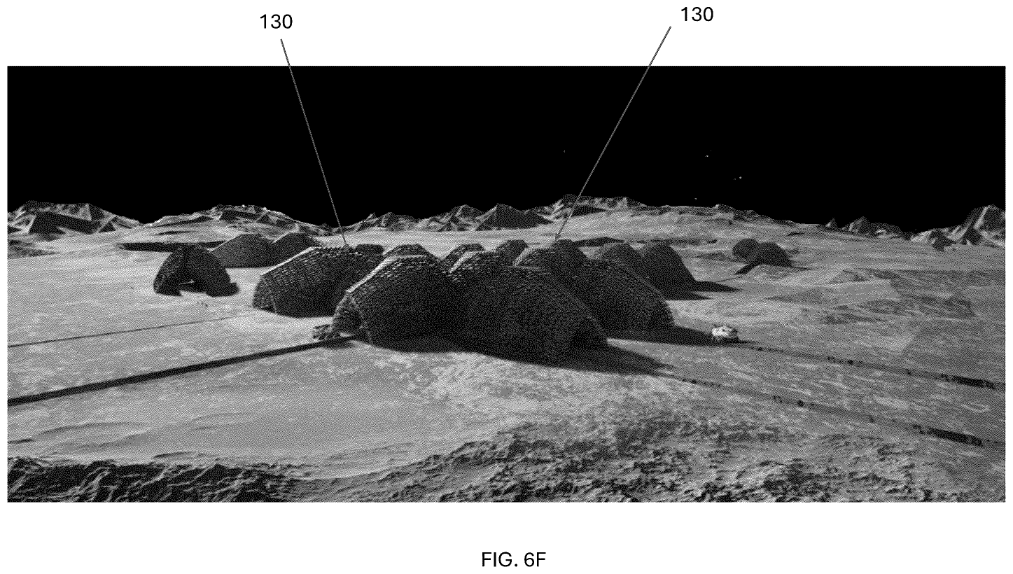

In some embodiments, the dimensions of the manufactured brick 100 can be about 1 meter tall and about 3.5 meters long, though bricks can be about 0.1 meters by 0.2 meters or approximately in a range of about 0.085 meters to about 1.115 meters by about 0.185 meters to about 0.215 meters. A thickness of the brick 100 with the loose regolith therein can be approximately in a range of about 0.5 meters to about 1 meter. The size selected has been driven by an initial effort to increase the span to height ratio of the resultant corbelled structure discussed with respect to FIGS. 6B-6E. In some embodiments, a nominal wall thickness can be about 2.54 cm (about 1 inch), and a total mass of the brick 100 filled with loose regolith can be about 7,500 kilograms, which can exert a load of about 12,250 Newtons based on known density properties of molten regolith and lower gravity on the moon. It will be appreciated that this larger brick size can be enabled by the reduced gravity on the moon.

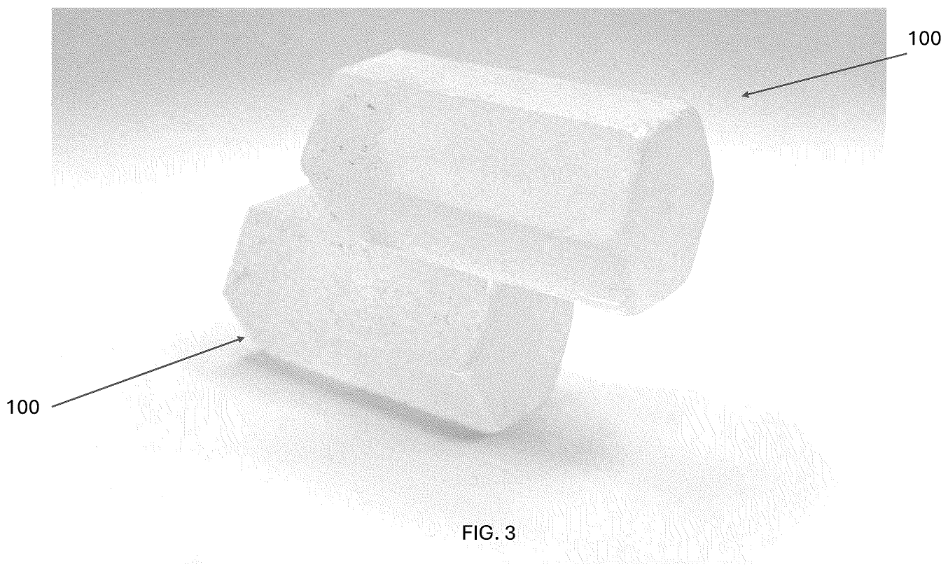

FIG. 3 illustrates an example of a plurality of bricks 100 being stacked relative to one another. The bricks 100 can be used to assemble a structure or dome 130 from the ground up, as shown in FIGS. 6B-6F, and to be stable without any external supports or centering, as discussed in greater detail below.

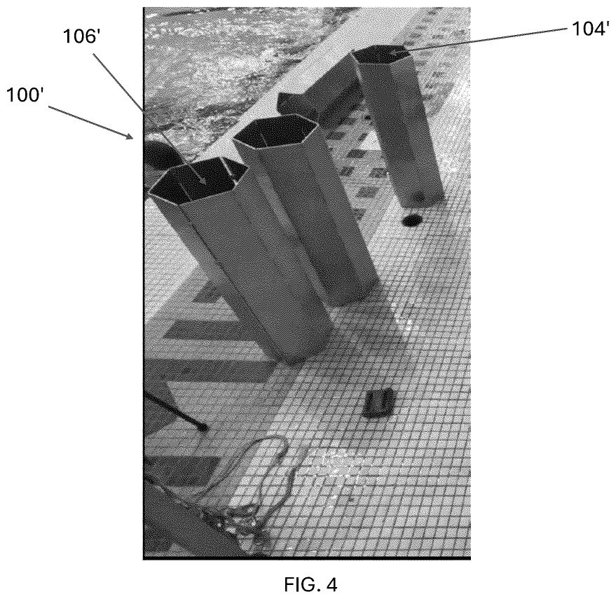

In some embodiments, a brick 100′ can be constructed with an opening 104′ in its hexagonal-face, as shown in FIG. 4. In such embodiments, regolith can be poured and/or otherwise inserted into the interior lumen 106′ to maintain the appropriate thickness for radiation shielding. A person skilled in the art will appreciate openings that provide exposure to an interior volume of a brick or other structure can be formed in other locations of a brick, and thus the illustrated embodiments of openings and bricks is by no means limiting.

Rather than assembling the bricks 100 using traditional human labor, which can introduce unnecessary risks for astronauts, in some embodiments, an autonomous assembly process can be used. That is, the molten regolith bricks 100 on the moon according to the present embodiments can be manufactured using an industrial automation system 110 which reduces the need for human intervention, thereby reducing risks associated with human error and human injuries. Molten regolith can be prepared and waste heat which will be handled with machinery made with ceramic materials to extend tool and machine life, reduce cold welding probability, and can be easily maintainable with replaceable parts. For example, preparation of molten regolith can occur by melting the regolith to a temperature of approximately in a range of about 1,000 degrees Celsius to about 1,500 degrees Celsius. Casting molds can be reusable and at the end of their life cycle can be replaced to ensure dimensional accuracy of bricks. Quality control via computer vision can be utilized to ensure dimensional accuracy and reduce manufacturing defects in brick manufacturing. Defective bricks can be remelted and reused to reduce waste.

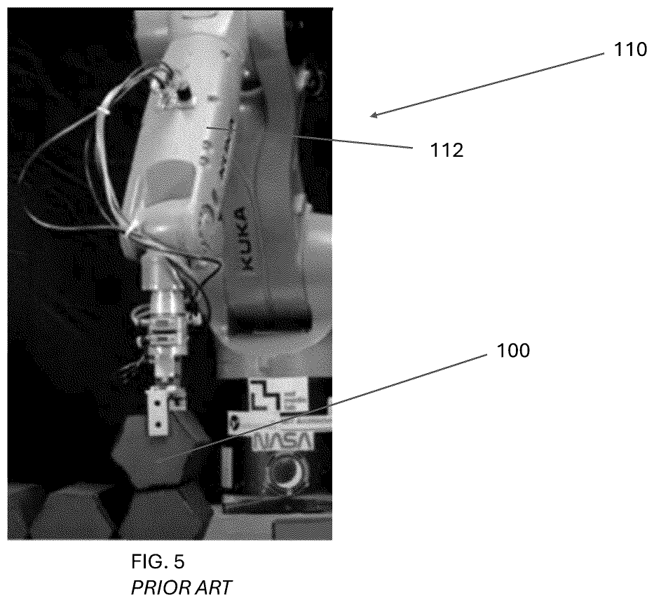

For example, assembly of the architectures using the system 110 can include grasping and lifting materials using a robotic arm 112, an example of which is shown in FIG. 5. In some embodiments, the system 110 can be a rover or other vehicle operable on the moon that can include a form of elevation platform that can extend over ten meters in height, while having the robotic arm of FIG. 5 on top, to assemble the top of the structures. The rover can be configured move and traverse the construction site while carrying the large robotic arm on top of its elevation platform. In other embodiments, stationary robots can be used or a stationary robot combined with a vehicle or the like that can provide movement can be used to build structures out of the bricks disclosed herein.

As shown, the arm 112 can be used to stack the bricks 100 in sequence to build the modular architectures of the present embodiments. The robotic arm 112 can be attached to a rover to reliably lift the masonry units and slide them into place. The robotic arm 112 can also have a reach of about 5 meters to about 10 meters to place the bricks at the top of the structure where the arch or dome curves. In some embodiments, the arm 112 can include a 6 degree-of-freedom robotic manipulator, such as produced by KUKA (Augsburg, Germany). Once the masonry units are transported to the building site, the system 110 can create structures that are at least 10 meters tall, as discussed above, in both arch and dome configurations to be compatible with different habitat morphologies.

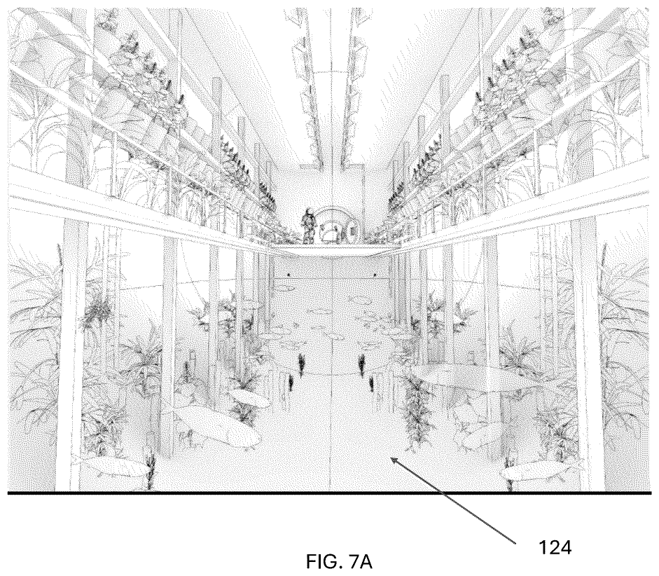

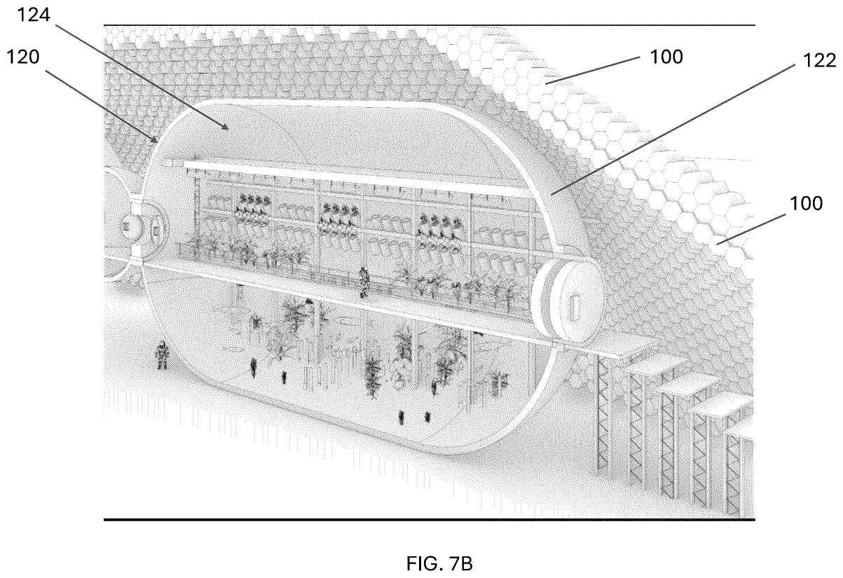

Construction of the architectures of the present embodiments can occur in a number of ways. For example, FIGS. 6A-6F illustrate an embodiment of the construction of a habitat or environment 120 of the present embodiments. As shown in FIG. 6A, an example habitat 120 can include one or more sidewalls or capsules 122 that have a hollow portion 124 therein. The sidewalls 122 can be expandable or inflated to expand within the hollow portion to form the habitat 120. The hollow portion 124 of each capsule 122 can include food production sources, greenhouses, recreation rooms, homes, offices, and other features that makes habitation on the lunar environment suitable. In some embodiments, the environment 120 can include a largest Sierra Space LIFE habitat and inflatable module at height and two LIFE modules, e.g., capsules 122, positioned from end-to-end. A detailed description of the contents of an example embodiment of the habitat 120 is found below in FIGS. 7A-7B.

FIGS. 6B-6E illustrate the gradual construction of a structure 130 that surrounds the habitat 120. The structure 130 can include a corbelled arch or catenary arch design. It will be appreciated that the catenary arch can provide a way to reduce energy demands on the manufacturing system, but would use an additional support structure as the arch is being assembled and would be susceptible to failure if a single brick fails. Therefore, the structures 130 of the present embodiments are built using corbelled arches, as shown. It will be appreciated that although the corbelled arch can use more bricks than a catenary arch, it achieves a more stable, maintainable structure. For example, the structure 130 can encompass about 2,000 bricks, about 5,000 bricks, about 10,000 bricks, about 15,000 bricks, about 20,000 bricks, or more, though in some embodiments, about 12,430 bricks can be used, which would translate to about a 3-month to 4-month construction window, while working 24 hours per day, with about 2 MW of power. This structure 130 can be freely assembled without any binders and formwork, enabling an adaptable, maintainable structure that is compatible with autonomous assembly. A cluster of such environments on the lunar surface are shown in FIG. 6F.

Manufacturing of the brick 100 to process the regolith can be accompanied by high energy demands in some embodiments, and efforts can be taken to minimize the energy used while also meeting the higher-level project requirements. For example, in some embodiments, a local manufacturing site can be chosen in a central place, such as on the lunar south pole, to supply radiation shielding to other lunar habitats. Power for the system 110 can be either distributed power across several manufacturing sites or at a single location.

FIGS. 7A-7B illustrate an embodiment of the habitat 120 in greater detail. As shown, the hollow interior portion 124 can include inflatable habitats to house astronauts and relevant pressurized habitats that are used for sustaining human presence on the moon such as agricultural farms, machine shops, crew living quarters, and more. These structures can allow for inflatable habitats to be deflated at the end of the habitat's life and replaced with a new habitat whenever necessary without having to disturb the brick structure. This demonstrates the permanence and the long lifetime of this radiation shielding structure 130.

Unlike long-spanning beams or joists, bricks are compact and relatively dense, so the internal stress in the structural members is not a major point of structural concern. When forming the corbelled arches of the structure 130 using the bricks 100 of the present embodiments, the rigid stability of the corbelled structure 130 can be consistently assessed, with the moments produced by members stacked above being confirmed to be sufficiently compensated by the weight of an individual brick. Optimizing the structure 130 and/or performing a systematic structural analysis can include performing balance calculations for each individual member, which can include one or more of: (1) harmonic numbers; and/or (2) Mycenacan Tholos Tomb. The harmonic analysis can leverage each subsequent shift of a block 100 that can be defined by a number in a geometric sequence starting from halfway at the top of the structure. The Mycenacan Tholos Tomb approach can be similar but allows analysis for bricks of different sizes and back-weighting to prevent tipping of the structures 130.

Additionally, there is a more detailed optimization that can be performed for the selection of the robotic architecture and the respective brick and structure dimensions, as the three are intimately related. The size of the bricks 100 can influence the span and the size of the structure 130, and the robotic architecture should be capable of lifting the brick 100. Though use of the KUKA robot 110 is assumed herein, many other robotic assembly architectures are possible.

For manufacturing, regolith and/or bricks 100 can be transported from their excavation location to their building site across large distances. For example, given that the lunar south pole region is several hundred kilometers wide, the brick transport method used can either traverse up to about 100 kilometers, or multiple manufacturing sites can be located around the lunar south pole, leading to construction of numerous structures 130, as shown, for example, in FIG. 6F.

Preparation of the bricks 100 of the present embodiments can occur in a variety of ways. For example, manufacturing of the bricks 100 of the present embodiments can occur via excavation of regolith and transport to the heating device, e.g., a furnace, stove, oven, or another heating device designed to melt objects, to be melted without beneficiation. The energy used to melt regolith to make an individual brick can be about 2600 MJ. The melted regolith can then be cast into the hollow brick 100 discussed above. The furnace can be powered with fission surface power (FSP) and/or solar power. FSP or solar power can generate reliable, constant power with little maintenance. Nuclear FSP can generate waste heat that will be radiated away due to no atmospheric convection processes on the moon.

The bricks 100 can be formed by casting regolith. Casting provides benefits to the stability of the structure 130 that other methods, such as additive manufacturing and various methods of sintering, cannot provide. For example, sintering methods are not practical at scale and do not produce the same material strength properties compared to molten additive manufacturing methods and casting. Moreover, while additive manufacturing can improve the flexibility of the kinds of bricks or structures that are printed, it is not beneficial when printing many of the same objects, as are the bricks 100 of the present embodiments. Moreover, additively manufactured structures are conventionally prepared as monolithic objects, which complicates repair in the event of breaking and/or cracking, often requiring re-printing of the entire structure, rather than replacing one or more modular bricks to which damage is localized. That is, it will be appreciated that each brick 100 can be substantially equal in size and/or shape, and can be filled with a substantially equal amount of loose regolith such that each brick 100 can have substantially the same weight. For the purposes of this disclosure, the term “substantially equal in size and/or shape” can refer to lengths, widths, and/or depths that are within about 10% of another brick, about 7% of another brick, about 5% of another brick, about 3% of another brick, about 1% of another brick, about 0.5% of another brick, and/or the same lengths, widths, and/or depths as another brick. Similarly, the term “substantially the same weight” can refer to a weight that is within about 10% of another brick, about 7% of another brick, about 5% of another brick, about 3% of another brick, about 1% of another brick, about 0.5% of another brick, and/or the same weight as another brick, with weight accounting for the reduced gravity on the moon. It will be appreciated that while the present disclosure provides for casting bricks 100 have the substantially equal shapes, styles, sizes, and/or weights, alternatively differently shaped, styled, sized, and/or weighted bricks can be produced and/or used.

Casting, on the other hand, is a simple manufacturing method and more energy-efficient than either of sintering or additive manufacturing. When casting, only a furnace is used to process and melt the regolith and no additional robotic components are used. Utilizing casting for identical units can have significant advantages over other construction methods. For example, casting can create stronger, more robust material than sintering, reduce robotic and computational complexity compared to 3-D printing. Casting hollow units can reduce energy demands and annealing time. For example, to manufacture individual units at a large industrial scale, a pressed glass casting system can be modified for compatibility with molten regolith that exits a heating device, such as a furnace. Moreover, casting the bricks 100 can allow replacement of one or more of the modular bricks as needed. For example, when a brick from the structure 130 is removed to form a void and a second brick is inserted to fill the void, no gaps are formed between the second brick and adjacent bricks after insertion due to the second brick sliding into place of the first brick when building the structure 130, as noted above.

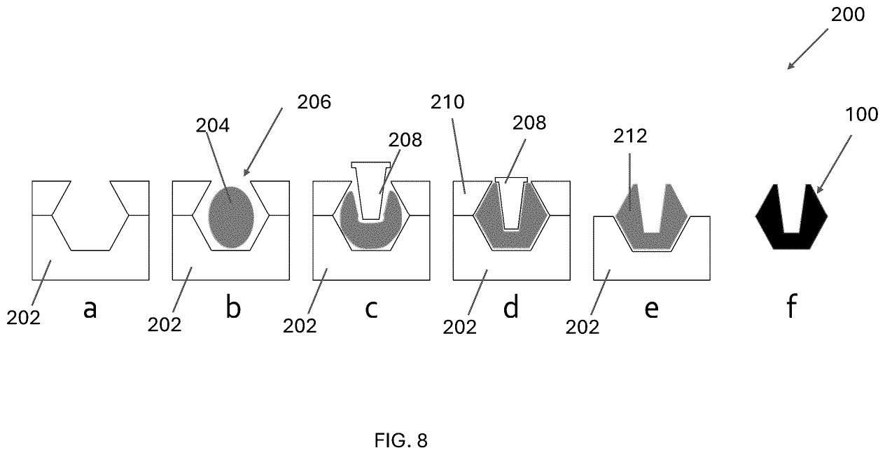

FIG. 8 illustrates one example of a method 200 of manufacturing the bricks 100 of the present embodiments. As shown, a mold 202 can be preheated and a release agent can be sprayed thereon, as shown in (a). In some embodiments, the mold 202 can be manufactured from boron nitride reusable molds, a ceramic stable in contact with molten regolith. A gobber, or a device that can measure, collect, or allow a predetermined amount of a substance to flow, can allow of molten regolith to flow through an orifice 206 of the mold 202 before being cut to a set of diamond shape shears, as in (b). The predetermined amount of the substance, which can be referred to as a gob 204, introduced by the gobber can be determined according to temperature-viscosity curves, as understood by one skilled in the art, and can be flowed into the mold 202 to fill the mold. It will be appreciated that the size of the gob can also vary based on a size of the mold 202, as well as other factors. A press with a plunger 208 in the shape of the negative, hollow space of the orifice 206, as shown in (c), can enter the mold 202 and force molten regolith to form up and around its sides. Pressing can continue, as shown in (d), until a final shape is formed and regolith temperature is below the softening point. The plunger 208, e.g., a ceramic plunger, and a top part 210 of the mold 202 can then be removed when the molten regolith material drops below the softening point, as in (e). The plunger 208 can be used to push the material around the mold 202 before cooling. The mold can then be opened, and a unit 212 can be removed to move to an annealing chamber for cooling and stress relaxation to form a final object, which is the brick 100, as shown in (f). The hollow brick 100 can then be filled with loose regolith, for example using the arm 112 once the annealing is complete. The bricks 100 can be transported to a construction site, where, in at least some embodiments, the above-described robotic arm 112 attached to a rover and a vertical elevating platform can assemble the bricks into the corbelled arches of the structure 130. It will be appreciated that molten regolith is used instead of studio-casting glass billet.

Delivery of the regolith to the heating device can occur autonomously via the robotic system 110. It will be appreciated that autonomously delivery of the regolith at height of the heating device can save on power demands, while also being strong enough to be able to traverse distances to obtain loose regolith with an internal power source.

It will be appreciated that the domed architecture 130 of the present embodiments has the potential to service a myriad of construction sites. Once a structure is completed, the radiation structure can be easily reused and maintained, for example by replacing the inflatable/pressurized modules that remain inside, enabling permanent surface habitation. The bricks 100 can also be reused and assembled into different configurations as needed. At the end-of-life of a manufacturing site, the heating device(s), excavators, and electronics can either be outfitted for other manufacturing/construction needs, or they can be recycled and used as scrap metal and resources used by other lunar habitats. It will be appreciated that the structures 130 of the present embodiments can be domes and/or dome-shaped that can be fully enclosed and/or partially enclosed, such as structures having one more openings formed therein, with the openings capable of serving as an entrance, an emergency exit, and so forth formed therein. Both domes and/or dome-shaped structures fall within the scope of the present disclosure. It will also be appreciated that the system of the present embodiments, including the robotic components, can be designed to overcome specific risks associated with the lunar environment and the autonomous nature of the construction process. For example, robotic components involved in construction can be designed to withstand the lack of atmosphere on the moon and the extreme temperature variations, which can include joints and assembly techniques that compensate for thermal expansion and contraction and shield critical components against cosmic and solar radiation. The rovers discussed above can be equipped with cameras that can perform object detection programming to recognize humans within reach. Continuous monitoring and diagnostic systems can be integrated into the construction systems to detect and respond to faults in real-time. Machinery used to manufacture the bricks 100 can also be designed to overcome specific risks associated with the lunar environment and can, in some embodiments, behave differently than their counterparts on Earth. For example, the mold 202 can be be reusable and made of a ceramic material capable of handling molten regolith for multiple cycles. The unique lunar environment that includes a vacuum will change the method of cooling of the cast brick since convection cooling is not possible, with thermal radiation and conduction playing a large role. The manufacturing process can be robotically performed compared to operations on Earth. The bricks, which as described herein can be hexagonal and hollow in some embodiments, can have a different mold design to accommodate the design and lower processing requirements. The methods for heating the regolith can also differ from methods on Earth. For example, natural gas fired blast furnaces are typically used for glass manufacturing process, but an electric melt furnace, among other heating device options, can be used on the moon as per the scope of the instant disclosure.

One skilled in the art will appreciate further features and advantages of the disclosures based on the provided for descriptions and embodiments. Accordingly, the inventions are not to be limited by what has been particularly shown and described. To the extent the present disclosure includes illustrations and descriptions that include prototypes, bench models, or schematic illustrations of set-ups, a person skilled in the art will recognize how to rely upon the present disclosure to integrate the techniques, systems, devices, and methods provided into a product and/or method of manufacturing the bricks of the present embodiments.

What is claimed is:

1. A method of minimizing radiation exposure, comprising:
manufacturing one or more bricks from loose regolith, the one or more bricks being formed by:
melting loose regolith to form a molten regolith; and
casting the molten regolith into a hollow hexagonal prism brick; and
assembling the one or more bricks into a structure having corbelled arches, the structure encasing a habitation in an interior hollow portion thereof.

2. The method of claim 1, further comprising filling the one or more bricks with loose regolith.

3. The method of claim 1, wherein casting the molten regolith further comprises:
transferring a gob having a volume of the molten regolith into an opening of a mold to shape the one or more bricks, the mold having a top portion and a bottom portion;
pressing the gob with a plunger having a shape of a negative, hollow space of the opening of the mold;
continuing pressing the gob until a final shape and a temperature of the molten regolith is below its softening point;
removing the plunger and the top portion of the mold;
removing the one or more bricks from the mold; and
annealing and cooling the one or more bricks.

4. The method of claim 1, further comprising preheating the mold.

5. The method of claim 1, wherein assembling the one or more bricks into the structure further comprises grasping and placing the one or more bricks on one another using a robot assembly system.

6. The method of claim 1, wherein the one or more bricks are glass-casted.

7. The method of claim 1, further comprising removing a first brick of the one or more bricks from the structure having corbelled arches to form a void and inserting a second brick of the one or more bricks to fill the void.

8. The method of claim 7, wherein no gaps are formed between the second brick and adjacent bricks when the second brick is inserted to fill the void.

9. The method of claim 1, wherein the loose regolith is melted in a furnace powered by at least one of fission surface power or solar power.

10. A structure, comprising:
a sidewall composed of molten regolith that is cast into a hexagonal prism shape with one or more faces of the sidewall defining an opening having an interior lumen formed therein.

11. The structure of claim 10, wherein the interior lumen contains loose, unrefined regolith.

12. The structure of claim 10, wherein a thickness of the sidewall is about 2.54 centimeters.

13. A radiation shielding structure, comprising:
a plurality of bricks composed of cast molten regolith, each brick of the plurality of bricks having a hollow interior portion filled with loose regolith, the plurality of bricks being assembled into corbelled arches having an inner volume defined therein.

14. The structure of claim 13, wherein each brick of the plurality of bricks has a hexagonal prism shape.

15. The structure of claim 13, wherein the structure is devoid of metal supports, mortar, or binders.

16. The structure of claim 13, wherein each brick of the plurality of bricks has a substantially equal height, length, and width as another brick of the plurality of bricks.

17. The structure of claim 13, wherein each brick of the plurality of bricks has a substantially equal weight as another brick of the plurality of bricks.

18. The structure of claim 13, wherein the plurality of bricks having corbelled arches is stable without external supports or centering.

19. The structure of claim 13, wherein the inner volume comprises a habitation that is configured to be inflated to fill the inner volume, the habitation being capable of supporting human life.

20. The structure of claim 19, wherein the habitation includes structures based on at least one of harmonic numbers or Mycenaean Tholos Tomb.
